(19) United States
(12) Patent Application Publication
(10) Pub. No.: US 2004/0071181 A1
(43) Pub. Date: Apr. 15, 2004

(54) Retro-reflective etalon and the devices using the same

(76) Inventor: Rong Huang, Westborough, MA (US)

Correspondence Address: RONG HUANG, 2107 WINDSOR RIDGE DRIVE, WESTBOROUGH, MA, 01581, US

(21) Appl. No.: 10/604,041

(22) Filed: Jun. 24, 2003

Related U.S. Application Data
(60) Provisional application No. 60/418,613, filed on Oct. 15, 2002.
(60) Provisional application No. 60/468,011, filed on May 5, 2003.

(51) Int. Cl. H01S 3/10; H01S 3/08

(52) U.S. Cl. 372/106; 372/20; 372/92

(57) ABSTRACT

Described are optical devices called retro-reflective etalon filter and wide tunable semiconductor lasers using the retro-reflective etalon filter. The reflection optical spectrum of the retro-reflective etalon has the double-pass transmission characteristic of the etalon used within the retro-reflective etalon. The retro-reflective etalon(s) can be used as the reflective end mirror(s) of the wide tunable semiconductor laser. The retro-reflective etalon also can act as the wavelength locker of the laser. The proposed retro-reflective etalon is easy to be manufactured and the wide tunable semiconductor lasers are easy to be implemented by using the retro-reflective etalon.

### CROSS REFERENCE TO RELATED APPLICATIONS

This application is entitled to the benefits of U.S. Provisional Application Ser. No. 60/418,613 filed Oct. 15, 2002 and U.S. Provisional Application Ser. No. 60/468,011 filed May 5, 2003, the disclosures of which are incorporated herein by reference.

### BACKGROUND OF INVENTION

Wavelength division multiplexing (WDM) systems typically comprise multiple separately modulated lasers as transmitters. These laser transmitters are designed or actively tuned to operate at different standard wavelengths, usually at the wavelengths specified by International Telecommunication Union (ITU) as Î½ₙ=Î1/2ₒÂ±nÃ [symbol] [symbol] ½, where Î½ₒ is the central optical frequency 193.1 THz and Î [symbol] ½ is the specified frequency channel spacing that may equal a multiple of 100 GHz or 50 GHz. The similar characteristic of equal frequency spacing between the modern WDM optical communication system and etalon optical filter finds many applications of the etalon filter in the WDM optical communication system. However, the etalon is usually used in its transmission mode for its desired characteristic. And the etalon must be positioned an angle against the optical path to avoid the interference resonance or the reflection from the etalon entering the optical path. That a simple and concise optical device has the reflection spectrum with the transmission characteristic of the etalon and can be freely set in the optical path is highly desirable in multi-applications, such as being used as a laser cavity reflector. The reflection type tunable etalon filter has been revealed for instance in the U.S. Pat. No. 5,666,225 issued to Colbourne. However, in the instance the incident optical beam must be presented an angle to the etalon to avoid the back-reflection from the etalon into the optical path, which obviously introduces high loss and the returning beam has a different optical path from the incident one.

The advantage of WDM systems is that the transmission capacity of a single fiber can be increased. Historically, only a single channel was transmitted in each optical fiber. In contrast, a modern WDM system accommodates hundreds of spectrally separated channels per fiber. This yields concomitant increases in the data rate capabilities of each fiber. Moreover, the cost per bit of data in WDM systems is typically less than comparative non-multiplexed systems. This is because optical amplification systems required along the link is shared by all of the separate wavelength channels transmitted in the fiber. With non-multiplexed systems, each channel/fiber would require its own amplification system.

Nonetheless, there are challenges associated with implementing WDM systems. First, the transmitters and receivers are substantially more complex since, in addition to the laser diodes and receivers, optical components are required to combine the channels into, and separate the channels from, the WDM optical signal. Moreover, there is the danger of channel drift where the channels lose their spectral separation and overlap each other. This interferes with channel separation and demodulation at the receiving end.

Minimally, the optical signal generators, e.g., the semiconductor laser systems that generate each of the optical signals corresponding to the optical channels for a fiber link, must have some provision for wavelength control. Especially in systems with center-to-center wavelength channel spacing of less than one nanometer (nm), the optical signal generator must have a precisely controlled carrier wavelength. Any wander impairs the demodulation of the wandering signal at the far end receiver since the wavelength is now at a wavelength different than expected by the corresponding optical signal detector, and the wandering signal can impair the demodulation of spectrally adjacent channels when their spectra overlap each other.

In addition to wavelength stability, optical signal generators that are tunable are also desirable for a number of reasons. First, from the standpoint of manufacturing, a single system can function as the generator for any of the multiple channel wavelength slots, rather than requiring different, channel slot-specific systems to be designed, manufactured, and inventoried for each of the hundreds of wavelength slots in a given WDM system. From the standpoint of the operator, it would be desirable to have the ability to receive some wavelength assignment and to have a generator producing the optical carrier signal into that channel assignment on-the-fly. Finally, in higher functionality systems such as wavelength add/drop devices, wavelength tunability is critical to facilitate dynamic wavelength routing, for example.

With so much interest in laser tunability, many different technologies are vying to become the choice of future optical networks. Currently there are four primary approaches to providing tunability with semiconductor laser as well as some new development such as quantum dots and two-laser pumping. Approaches include DFB lasers, distributed Bragg reflector (DBR) lasers, vertical cavity surface emitting laser (VCSELs) employing micro-electro mechanical systems (MEMS) technology, and external-cavity diodes lasers (ECLs). The ultimate tunable-laser solution will supply high output powers over wide tuning ranges in a compact and reliable package, with a proven and scalable manufacturing plan and competitive cost to existing solutions.

To place a tunable filter in the external cavity of a laser diode to control the wavelength is a well-known art. As revealed in U.S. Pat. No. 4,897,843 issued to Scott, U.S. Pat. No. 5,121,399 to Sore et al, U.S. Pat. No. 4,727,552 issued to Porte et al, birefringent crystal materials are required in the laser cavity, together with linear polarizers to form a polarization interference filter. In U.S. Pat. No. 6,526,071 issued to Zorabedian et al, U.S. Pat. No. 5,949,801 to Tayebati, U.S. Pat. No. Asami, U.S. Pat. No. 6,301,274 to Tayebati et al, a wide tunable etalon filter is used in the cavity. To make such widely tunable filter and to align the filter against the optical path are a difficult task. Asami”s patent, using the tunable etalon filter selects a wavelength from a comb-like reflection spectrum produced by cascaded FBG gratings.

To integrate all tunable elements and gain section on one substrate as described in U.S. Pat. No. 4,896,325 issued to Coldren et al looks avoiding some problems suffered in external cavity laser construction. Two end mirror reflectors are made with narrow, spaced reflective maxima in which the maxima spacing is different in one mirror from that of the other, and are bounding the active gain element to form a laser cavity. The tuning is accomplished by so-called Vernier effect as described in the article “Crosstalk Analysis and filter optimization of single- and double-cavity Fabry-perot filters”, IEEE J. of selected areas in communications, 8(6), pp. 1095-1107, 1990. The limitation to the above patent disclosures is the very complicated wavelength setting and calibration besides possible fast wavelength setting and integration with other functional optical devices, such as optical modulator. Usually, a complicated optical device called wavelength locker is used to control its long-term wavelength stability and re-calibration may be needed for the device on some points during its service, as analyzed in the publication by Gert Sarlet et al “Control of widely tunable SSG-DBR lasers for dense wavelength division multiplexing”, J. Lightwave Tech. 2000, 18(8), pp. 1128-1138. It is very useful to make the device simple and easy control with long term wavelength stability instead of recalibration during its application.

### SUMMARY OF INVENTION

A retro-reflective etalon (R-etalon) have been proposed in this invention. The R-etalon has a reflection spectrum of a plurality of peaks. Within the R-etalon, there are an etalon, which has two partially reflective mirrors, or surfaces, facing each other and separated by a certain gap which forms a cavity, two polarization rotation elements, one or two polarizers and a partially reflective or perfectly reflective mirror. The reflection optical spectrum of the R-etalon has the double-pass transmission characteristic of the etalon. The transmission optical spectrum of the R-etalon is with the transmission characteristic of the etalon.

The etalon is arranged in between two polarization rotators, such as Faraday rotator or quarter waveplate. At the one side of such device, a polarizer and a mirror are arranged sequentially. On the other side of the device, a polarizer sits, as shown in FIG. 1a. Physical contact or applying some adhesives may laminate all these components sequentially together, as illustrated in FIG. 1b. During the arrangement, using anti-reflection coating or applying refractive index matching adhesive minimize the reflection from the surface of the components and the interfaces between bonded two components.

When light passes through the first polarizer, the light becomes linearly polarized. The polarization of the light rotates 45 degree after it passes through the first Faraday rotator. The polarization of the reflected light from the etalon rotates another 45 degree and absorbed by the first polarizer. The polarization of the light after passing through the etalon and the second polarization rotator rotates another 45 degree. The second polarizer is so arranged to allow the light passing through. Then, the light is totally or partially reflected back from the mirror. The reflected light passes through the second polarizer and the second Faraday rotator again and its polarization rotates 45 degree before it passes through the etalon. The second polarization rotator rotates the polarization of the light reflected back from the etalon another 45 degree and the second polarizer absorbs the light. As the result, the resonance between the mirror and the etalon is dramatically reduced. After the light passes through the etalon and the first Faraday rotator the second time, the polarization of the light rotates another 45 degree. Its polarization changes totally 180 degree and it then passes through the first polarizer. The second polarizer with the second Faraday rotator can effectively eliminate the resonance between the mirror and the etalon even though the two components are put in perfect parallel.

If using quarter waveplates in the places of Faraday rotator, the similar principle is applied. When light passes through the first polarizer, it becomes linearly polarized. When the polarized light passes through the first quarter waveplate, it becomes a circularly polarized light. The circularly polarized light reflected back from the etalon passes through the first waveplate again and becomes a linearly polarized; but its polarization rotates overall 90 degree. The first polarizer absorbs the light. The light passing through the etalon passes through the second quarter waveplate and becomes linearly polarized. The second quarter waveplate may be arranged to enhance or counter the effect of the first quarter waveplate. The second polarizer is arranged to allow it pass through. Then, the light reflects totally or partially back from the mirror. The reflected-back light passes the second quarter waveplate and becomes circularly polarized again. The partial of the light is reflected back from the etalon and passes the second quarter waveplate again and becomes linearly polarized and absorbed by the second polarizer. The light passing through the etalon and the first quarter waveplate becomes linearly polarized again. The polarization changes totally 180 degree or 0 degree. It passes through the first polarizer. As the result, the light reflected from the device passes through the etalon twice and has the double-pass transmission characteristic of the etalon. If the R-etalon is positioned perpendicular to the optical path, the peak positions of the R-etalon are much less sensitive to the beam steering (the beam direction deviating from the normal of the etalon).

R-etalon can act as one or two end reflectors of a laser cavity. In one embodiment presented in this invention, the R-etalon acts as one end mirror of a laser cavity with an extended semiconductor optical amplifier, as illustrated in FIG. 3. The R-etalon whose peak wavelengths are set to match the ITU wavelengths also acts as the wavelength locker. The wavelength locker is an optical device setting the lasing wavelength to a specific wavelength, usually one of ITU wavelengths. The peak wavelengths of the R-etalon can be adjusted thermally or electrically. The adjustment depends on the material used in the etalon cavity. If using two R-etalons as the two end reflectors of a laser cavity, one etalon can act as the wavelength locker and another one acts as wavelength tuner, as shown in FIG. 6. Using R-etalon in the external cavity laser, only one action is needed to align the etalon and the reflector against the optical path.

The above and other features of the invention including various novel details of construction and combinations of parts, and other advantages, will now be more particularly described with reference to the accompanying drawings. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF DRAWINGS

In the accompanying drawings, reference characters refer to the same parts through the different views. The drawings are not necessarily to scale; emphasis has instead been placed upon illustrating the principles of the invention. Of the drawings:

FIG. 1a is a schematic drawing to show the R-etalon with its components and arrangement sequence.

FIG. 1b shows schematically the R-etalon with all its components laminated together.

FIG. 2 shows the measured reflection spectrum of a constructed R-etalon with two Faraday rotators.

FIG. 3 illustrates the application of the R-etalon in one laser cavity embodiment.

FIG. 4 illustrates the end mirror reflector having a band-pass characteristic.

FIG. 5 shows schematically the spectra of a R-etalon (a) and a reflective grating (b) and the resultant spectrum (c).

FIG. 6 illustrates the application of the R-etalon in another laser cavity embodiment.

FIG. 7 shows the application of the R-etalon in another laser cavity embodiment and the cavity phase compensation by sitting a R-etalon on a piece of piezo-electrical substrate.

FIG. 8 illustrates another embodiment to implement a retro-reflective etalon.

### DETAILED DESCRIPTION

The proposed R-etalon comprises an etalon and a few other optical components, such as Faraday rotator, polarizer or quarter waveplate. All components are commercially available or easily manufactured by existing technology. Its reflection optical spectrum has the double-pass transmission characteristic of the etalon. The etalon can be made of a solid material or air-spaced. To achieve required the reflectivity of the etalon, its surface can be coated multi-layers of dielectric materials, as known in the art. The etalon can be designed to have specific free space range (FSR) by using different spacing thickness or different material with a different refractive index.

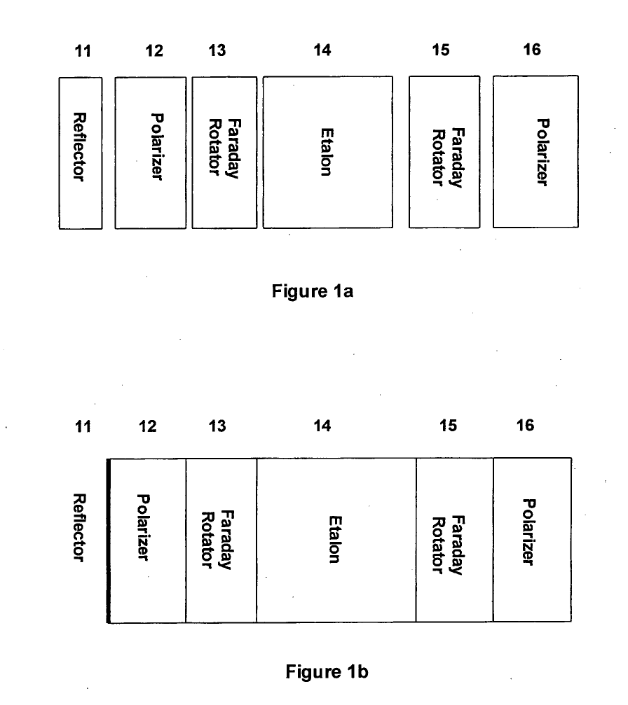

FIG. 1 shows the arrangement of the proposed R-etalon. The arrangement reduces dramatically the interference between the etalon 14 and the reflector mirror 11, which is arranged substantially in parallel to the etalon. The reflector mirror 11 reflects totally or partially the incoming light. In order to save cost and space, this reflective mirror can be a reflection coating on the optical linear polarizer 12. The light incident on the R-etalon is reflected back with the double-pass characteristic of the etalon. The light beam points perpendicularly to the device. The polarization rotators 13, 15 can be Faraday rotators or quarter waveplates. The linear polarizer allows the light of the polarization in parallel to its polarization axis passes through and the light then becomes linearly polarized.

The operating principle of the device is as following. When light passes through the first polarizer 16, the light is linearly polarized. The polarization of the light rotates 45 degree after it passes through the first Faraday rotator 15. The polarization of the reflected light from the etalon rotates another 45 degree by the first Faraday rotator and the polarizer 16 absorbs it. The polarization of the light passing through the etalon rotates another 45 degree by the second Faraday rotator 13. The second polarizer 12is so arranged to allow the light passing through. Then, the light is totally or partially reflected back from the mirror 11. The reflected light passes through the second polarizer 12 again and when it passes through the second Faraday rotator 13, its polarization rotates another 45 degree. The light reflected back from the etalon 14 goes through the second polarization rotator again. And the second polarizer 12 absorbs it. As the result, the resonance between the mirror 11 and the etalon 14 is dramatically reduced, even though the mirror is in perfect parallel to the etalon. The light passing through the etalon 14 goes through the first Faraday rotator 15 second time. The polarization of the light rotates another 45 degree. The polarization of the light changes overall 180 degree; and it passes through the first polarizer 16.

If using quarter waveplates in the places of Faraday rotator, the same principle is applied. When light passes through the first polarizer 16, it becomes linearly polarized. When the linearly polarized light passes through the first quarter waveplate 15, it becomes a circularly polarized light. The light reflected back from the etalon 14 passes through the first waveplate 15 twice and becomes linearly polarized; but its polarization rotates overall 90 degree and the first polarizer 16 absorbs it. When the light passes through the etalon 14 and the second quarter waveplate 13, it becomes linearly polarized again. The second polarizer 12is so arranged to allow it passing through. Then, the light reflects totally or partially back from the mirror 11. The reflected-back light passes the second polarizer 12 and the second quarter waveplate 13 again and becomes circularly polarized. The circularly polarized light reflects back from the etalon 14 and passes the second quarter waveplate 13 twice and it becomes linearly polarized and is absorbed by the second polarizer 12. The light passing through the etalon 14 goes through the first quarter waveplate 15 second time and becomes linearly polarized. The polarization changes overall 180 degree or 0 degree, which depends on the arrangement of the first and second quarter waveplates and then it passes through the first polarizer 16. As the result, the light reflected from the device passes through the etalon twice and has the transmission characteristic of the etalon with a higher finesse.

FIG. 1b shows a R-etalon with all its components laminated together. The end mirror 11 is a reflective coating on the polarizer 12. In order to save assembly cost, a large piece of laminated R-etalon can be made; then it is diced into small pieces with a required size. The advantage of the laminated retro-reflective etalon is the ease to assembly and the TM simplicity to align. For example, if the polarizer 12is a Polarcor™ linear polarizer and the waveplate 13 is made from quartz, two pieces can be epoxied together by using an index-matching epoxy or just by using optical contact, since the Polarcor™ has a refractive index very close to that of the quartz. The reflection at the interface is very small by the formula, R=[(nₚ−n_{q})/(nₚ+n_{q})], where R is the reflectivity, nₚ is the refractive index of the Polarcor™ and n_{q} is the refractive index of the quartz. If the refractive index difference is large between two components, some kind of coating should be applied first before using epoxy or optical contact method to minimize the interface reflection.

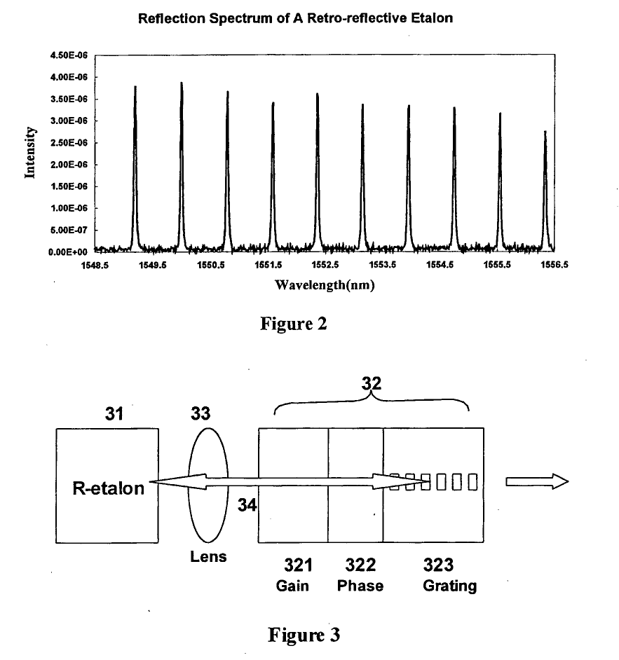

The etalon 14 in the R-etalon can be an air-spaced etalon, which is made little temperature-dependence or a solid etalon. Usually, the refractive index of the solid material in the etalon cavity is wavelength dependent, or called dispersion. Because of the interested frequency range is usually very small, for example, “C” band or “L” band, the dispersion is approximated as a linear function of frequency. During the design, the linearly frequency-dependent dispersion can be compensated by finding the etalon thickness using the formula L=kc/[2(n(Î½)Î½−n(Î½−K*FSR)(Î½−k*FSR))], where L is the thickness of the etalon, k is an integer, c is the speed of light, Î½ is the frequency, and FSR is the designated free space range. The k is chose to let Î½ to Î½−k*FSR to cover the central half of the interested frequency range. Because the refractive index and the physical thickness of the solid material can be easily adjusted thermally, the FSR of the etalon alters accordingly. If the material has electro-optical, magnetic-optical, piezo-electrical properties, applying electrical or magnetic field can change the FSR of the said etalon, too. Then, the peaks of the R-etalon can be adjusted to match to ITU frequencies in the interested frequency range. FIG. 2 shows the measured reflection spectrum of a constructed R-etalon, in which two Faraday rotators were used.

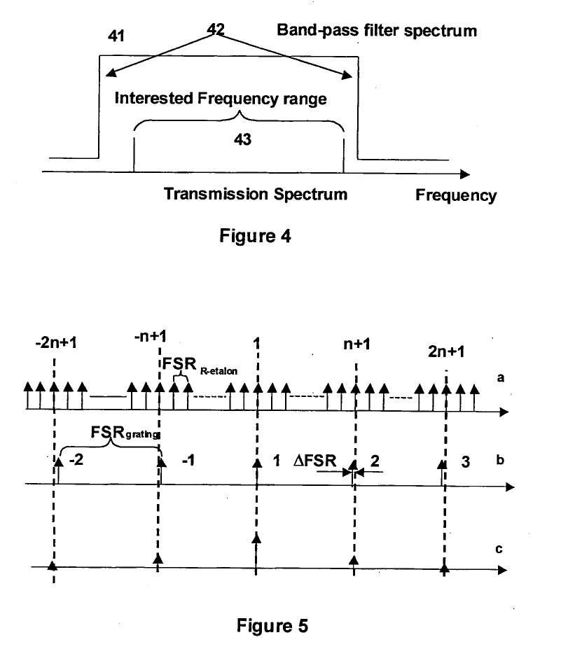

FIG. 3 proposes an embodiment to show the application of the R-etalon in a laser cavity. In the embodiment, there is an extended semiconductor optical amplifier (SOA) gain section 32in the cavity. The extended SOA has a sampled grating or super structure grating 323 on it, or any gratings known in the art that exhibits a comb-shaped reflection spectrum. The grating serves as a tuning filter by injecting current into it. The reflection spectrum of the grating has slightly different peak spacing from the multiple FSR of the R-etalon 31. FSR_{gratin}=nÃ [symbol] SRₑₜₐₗₒₙÂ±Î [symbol] SR, where FSR_{grating} is the peak spacing of the grating; n is an integer; FSRₑₜₐₗₒₙ is the FSR of the R-etalon; and Î [symbol] SR is the fraction of FSRₑₗₜₐₒₙ. The resultant FSR of the two filters is mFSR_{grating}, where m is equal to int(FSRₑₜₐₗₒₙ/Î [symbol] SR). The current injection into the grating section 323 changes the frequency of reflection peaks. The frequency tuning range of the grating is expected at least to cover one FSR_{grating}. For stable single mode operation, a peak of the grating 323, and one peak of the R-etalon 31, and one longitudinal mode of the cavity have to be aligned. If the grating reflector is tuned by the current injection, one peak of the grating reflector 323 overlaps one reflection peak of the R-etalon filter 31, and the lasing frequency will jump by approximately the FSR of the grating 323 (course tuning). For fine-tuning, the longitudinal cavity modes are shifted by injecting current into the phase section 322 to align the longitudinal mode to the coarsely tuned frequency. The extended SOA has two lower reflection (anti-reflection coating) facets. The lens 33 collimates the emission from the SOA toward the R-etalon 31. Fortunately, the emission light from the SOA is substantially polarized. The first polarizer 16of the R-etalon 31 should be aligned with the polarization of the emitting light from the SOA. Actually, the first polarizer 16is not necessary in this case. The reason is that the light reflected back from the etalon 14 has a polarization perpendicular to the polarization of the light emitted from the gain section 321 and is not amplified by it. The reflection peaks of the R-etalon 31 are aligned thermally or electrically to the ITU frequencies within the tolerance of the required accuracy. The R-etalon 31 acts as the wavelength locker of the laser cavity, because the laser only lases at the frequencies matching reflection peaks of the R-etalon. The end mirror can be coated with some features to allow the absolute identification of the lasing frequency. FIG. 4 shows that the end mirror is a band pass filter, in which the band covers the interested frequency range 43. The end mirror also can be a low pass filter or high pass filter. The edge of the filter provides an absolutely frequency identification. Beyond the edge of the filter, the laser does not lase due to the high loss. The end mirror reflector may also have a special transmission characteristic within the interested frequency range to compensate the gain characteristic of the gain medium. As the result, a substantial flat gain curve is achieved. The R-etalon is positioned perpendicular to the optical path. Therefore, the peak frequencies of the R-etalon are much less sensitive to the beam steering and the component misalignment. The use of the R-etalon also reduces the external cavity length and increases the mode separation of the cavity to lower the possibility of mode hopping between the cavity modes.

The FSR of the R-etalon for wavelength locker purpose can be set at 200 GHz, 100 GHz, or less. The selection of the FSR depends on the peak width of the reflective grating and the Î [symbol] SR. However, if the large FSR is used for the locking R-etalon, its peak positions can be shifted thermally or electrically to access any ITU frequencies. For example, if the FSR of the R-etalon is 200 GHz, its peak frequencies are set at the frequencies defined by ITU for 200 GHz DWDM system. These frequencies are also a set of frequencies defined by ITU for 100 GHz DWDM system. To access another set of frequencies defined by ITU for 100 GHz DWDM system, the peak frequencies of the R-etalon should be shifted 100 GHz thermally or electrically, which depends on the material used for the etalon. Actually, by shifting the peak frequencies of the R-etalon, the laser can lase on any expected frequency.

Besides the sampled grating or superstructure grating, whose reflection shows the comb-like spectrum, the digital grating can be used too. It consists of a multiple grating sections and each section can be addressed (or injected current) independently. Each section has its individual pitch and exhibits single peak reflection spectrum within the interested frequency range. The resultant spectrum has a comb-like spectrum. Each peak can be shifted individually by injecting current into its grating section. Initially, the frequencies of all reflection peaks are designed to be between the two adjacent peaks of the R-etalon. As the result, the reflection peaks match no reflection peaks of the R-etalon. The frequency of the peak of each sub-grating can be adjusted by injecting current into the grating section. By matching the reflection peak from the sub-grating to the reflection peak of the R-etalon, the lasing frequency can be selected. The advantage of using digital grating is reducing the optical loss caused by injected electrons.

If not using the R-etalon, a reflector and an etalon can replace it. The etalon then must be set an angle against the optical path to avoid the interference resonance between the etalon and the reflector and the reflection from the etalon into the gain chip. To avoid the reflection from the etalon into the gain chip, two quarter waveplates or two Faraday rotators can be used. One is placed between the etalon and the gain chip and another one is placed between the reflector and the etalon. The etalon is still placed an angle against the optical path to avoid the interference resonance between the etalon and the end mirror reflector. These alternative embodiments are also thought in the scope of this invention.

In FIG. 5, it is assumed that the peak 1 of the R-etalon matches the peak 1 of the grating and the injection of current reduces the refractive index of the grating. When the current is injected into the grating section continually, the peak shifts towards right. The (mÃ [symbol] +I)th peak of the R-etalon matches the (m+I)th peak of the grating successively, where m is an integer from zero to int (FSR_{R-etalon}/Î [symbol] SR) for I to go from 1, 2, â [symbol] , to n. The other advantage of the using extended SOA is the possibility to integrate other optical devices with it, such as optical modulator.

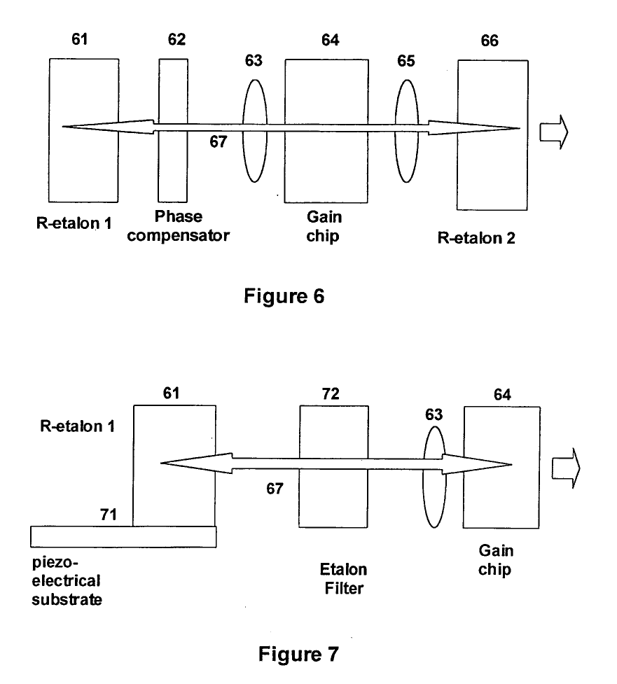

FIG. 6 presents another embodiment of using the R-etalon in the laser cavity. Two R-etalons 61, 66 act as two end mirrors of the laser cavity. At least one R-etalon has the first polarizer 16 withinit to eliminate the resonance between the two etalons in the two R-etalons. One of the two R-etalons 61 66 has its reflection peaks matching ITU wavelengths and acts as the wavelength locker. Another one (tuning R-etalon) can adjust its peak wavelengths thermally or electrically, which depends on the material used in the cavity of its etalon. The FSR difference between the two R-etalons is also described by the equation, FSR_{tuning}=nÃ [symbol] SR_{locking}Â+Î [symbol] SR, where FSR_{tuning} is the FSR of the tuning R-etalon and FSR_{locking} is the FSR of the locking R-etalon. To match the cavity mode to the overlapped peak of the two R-etalons, tunable cavity phase compensation is needed. As shown in the FIG. 6, an independent piece of component 62 is used as the phase compensator. Changing the thickness or refractive index or both thermally or electrically can change the optical path length of the light. The phase compensator can also be a section integrated with the SOA, as in previous embodiment. The optical path change is by injecting current into the phase section. Of course, there are other ways to implement the cavity phase compensation and the laser cavity. For example, by putting all components on a piece of piezo-electrical substrate or just putting one R-etalon on a piece of piezo-electrical substrate 71 illustrated in FIG. 7, the cavity length changes by applying an electrical voltage to the piezo-electrical substrate. FIG. 7 also shows another laser cavity embodiment using R-etalon. An etalon filter 72 is positioned between the R-etalon and the gain medium. The etalon filter or the R-etalon can be tuned a frequency range at least one its FSR. Another one sets its peaks to be ITU frequencies. The outside facet of the gain medium is reflection coated to form another reflector of the cavity. The etalon filter is set an angle to the optical path to avoid the reflection from the filter into the gain medium and the interference resonance between the filter and the R-etalon. Or a device with very R-etalon-like configuration can be constructed. The device can be positioned perpendicular to optical path to prevent the reflection from the etalon into the gain medium and to eliminate the interference resonance between the device and the R-etalon. The device is constructed by replacing the reflector of the R-etalon by an antireflection coating to let the light passing through. The second polarizer (close to the R-etalon) is omitted. To let the light passing through the R-etalon, the polarization axis of the first polarizer of the R-etalon is positioned perpendicular to the polarization axis of the first polarizer of the device.

The optical path compensator can also be integrated with the end mirror reflector. Usually, the end mirror reflector is a perfect or partial reflection coating on the front side (the side facing the gain chip) of a piece of transparent material, such as fused silica or lithium niobate. And the backside is anti-reflection coating. If the front side is antireflection coated and the backside is coated a perfect or partial reflection, the thickness of the reflector is a part of the cavity length. Changing the optical path of the reflector thermally or electrically compensates the cavity optical length.

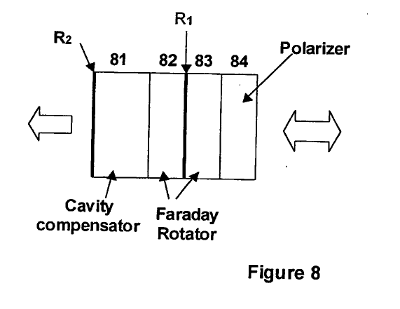

FIG. 8 shows another embodiment to implement a retro-reflective etalon. A Faraday rotator 82 with a cavity compensator 81 comprises the resonant cavity of a R-etalon sandwiched between two reflectors with reflectivity R₁ and R₂. Actually, the reflectors can be two reflection coatings on the Faraday rotator and the cavity compensator, as shown in the figure. The cavity compensator is used to achieve an accurate FSR of the etalon. Using cavity compensator is to de-couple the strict requirement of the FSR and the 45 degree polarization rotation requirement put on the Faraday rotator. Another Faraday rotator 83 is applied outside the etalon cavity to compensate the polarization rotation introduced by the Faraday rotator inside the cavity. The polarizer 84 absorbs the light reflected back from the reflector R₁ with a polarization perpendicular to its polarization axis. The reflection intensity with a polarization parallel to the polarization axis I^{r}_{//}=R₂(1−R₁)²/[(1−R₁R₂)²+4R₁R₂ cos²(Î′)], where Î′=4Ï [symbol] n_{c}d_{c}+n_{f}d_{f})/Î>>, in which n_{c}, d_{c} and n_{f}, d_{f} are the refractive index and the thickness of the cavity compensator and the Faraday rotator, respectively. The transmission intensity I^{t}=(1−R₁)(1−R₂)(1+R₁R₂)/[(1−R₁R₂)²+4R₁R₂ cos²Î′]. The reflection spectrum passing through the polarizer has the transmission characteristic of a normal etalon with twice thickness. However, the peak intensity is reflectance dependent and can be calculated by the above formula. A power monitor may be put behind the R-etalon to monitor the power output. Or power is coupled out from the cavity on the R-etalon side. The R₁ and R₂ should be selected according to the formula to balance the power output and the cavity power loss. Equally, the Faraday rotators can be replaced by two quarter-waveplates. The optical axes of the waveplates are set 45 degree against the polarization axis of the polarizer. The reflection intensity with a polarization parallel to the polarization axis I^{r}_{//}=R₂(1−R₁)²/[(1−R₁R₂)²+4R₁R₂sin²(Î′)], where Î′=4Ï [symbol] n_{c}d_{c}+n_{w}d_{w})/Î>> and n_{c}, d_{c} and n_{w}, d_{w} are the refractive index and the thickness of the cavity compensator and the quarter waveplate (fast axis″ or slow axis″), respectively. The transmission intensity I^{t}=(1−R₁)(1−R₂)(1+R₁ R₂)/[(1−R₁R₂)²+4R₁R₂ sin ²Î]. It is also well known in the art to make a zero order quarter waveplate by bonding two pieces of birefringent material together. The fast axis of one is aligned with the slow axis of another. To make a R-etalon by using the said technique, the thickness difference between the two pieces is determined by the quarter waveplate requirement and the total thickness is determined by the FSR requirement. As the result, both pieces have a strict thickness requirement.

While the invention has been shown and described with reference to specific preferred embodiment, it should be understood by those skilled in the art that various changes in form and detail may be made therein without departing from the spirit and scope of the invention as defined by the following claims.

1. A retro-reflective etalon (r-etalon) comprising:
an etalon filter;
two polarization rotators;
two linear polarizers; and
an end mirror reflector;
the components arranged in the sequence: the first linear polarizer, the first polarization rotator, the etalon filter, the second polarization rotator, the second linear polarizer, the end mirror reflector;
the end mirror reflector arranged in substantial or perfect parallel to the etalon filter;
the first polarization rotator to rotate the polarization of the light reflected from the etalon and to let the reflected light to be absorbed by the first polarizer;
the second polarization rotator to rotate the polarization of the light reflected from the etalon and to let it to be absorbed by the second polarizer.

2. The R-etalon of claim 1 wherein the etalon is an air-spaced etalon defined by a first partial reflector and a second partial reflector, said reflectors mounted in a parallel spaced-apart relationship to form a gap in between.

3. The R-etalon of claim 1 wherein the etalon is defined by a first partial reflector and a second partial reflector, said reflectors formed on the two parallel surfaces of a piece of transparent material and is dispersion compensated.

4. The etalon of claim 3 wherein the thickness or the refractive index or both of the transparent material can be changed thermally or by applying an electrical field.

5. The R-etalon of claim 1 wherein the two polarization rotators are Faraday rotators.

6. The polarization rotator of claim 5 wherein the Faraday rotator can rotate the polarization 45 degree.

7. The R-etalon of claim 1 wherein the two polarization rotators are quarter waveplate.

8. The two polarization rotators of claim 7 wherein the fast optical axes of the one quarter waveplate is aligned in parallel to the fast optical axis or slow optical axis of another quarter waveplate.

9. The two polarization rotators of claim 7 wherein the optical axis of the two waveplates are aligned 45 degree against the polarization of the incident light.

10. The R-etalon of claim 1 wherein the linear polarizer only lets light with the polarization in parallel to its polarization axis to pass through substantially.

11. A frequency tunable laser cavity comprising:
an extended gain chip generating substantially polarized light;
a R-etalon;
wherein, because of the light from the gain chip is substantially linearly polarized, the first polarizer in the R-etalon is not a must.

12. The laser cavity of the claim 11 wherein the R-etalon forms one reflector of the laser cavity.

13. The laser cavity of the claim 11 wherein the R-etalon is set that its peak wavelengths match to the ITU wavelengths within the required tolerance of accuracy and its FSR is set to the WDM channel spacing, such as 200 GHz, 100 GHz, 50 GHz.

14. The laser cavity of the claim 11 wherein the extended gain chip has a gain section, a phase section and a reflective grating section on it.

15. The extended gain chip of the claim 14 wherein the reflective grating comprises one of sampled grating, super structure grating and digital grating, which exhibits a comb-shaped reflection spectrum.

16. The extended gain chip of the claim 14 wherein the grating forms another reflector of the laser cavity.

17. The extended gain chip of the claim 14 wherein the FSR of the grating is slightly different from the multiple FSR of the R-etalon.

18. The extended gain chip of the claim 14 wherein the reflection peaks of the grating can be shifted by injecting current in the grating section.

19. The extended gain chip of the claim 14 wherein the phase section shifts the wavelengths of the cavity modes by injecting current in.

20. The laser cavity of the claim 11 wherein the R-etalon has an end mirror reflector comprising one of band-pass filter, low-pass filter, high-pass filter, and special filter to compensate the gain curve of the gain section.

21. A frequency tunable laser cavity comprising:
a gain chip generating substantially polarized light;
two R-etalons;
a cavity phase compensator;
wherein, because the light from the gain chip is substantially linearly polarized, only one of the two first linear polarizers in the two R-etalons necessary.

22. The laser cavity of the claim 21 wherein the two R-etalons form two end reflectors of the laser cavity.

23. The laser cavity of the claim 21 wherein one R-etalon (defined as the first R-etalon) is set that its peak wavelengths match to the ITU wavelengths within the required tolerance of accuracy and its FSR is set to the WDM channel spacing, such as 200 GHz, 100 GHz, 50 GHz.

24. The laser cavity of the claim 21 wherein the FSR of another R-etalon (the second one) is slightly different from the multiple FSR of the first R-etalon.

25. The laser cavity of the claim 21 wherein the FSR of the second R-etalon is tunable.

26. The laser cavity of the claim 21 wherein the phase compensator is a slab of transparent material with two antireflection coated parallel facet.

27. The phase compensator of the claim 26 wherein the slab can changes its thickness or refractive index or both thermally or electrically.

28. The laser cavity of the claim 21 wherein the phase compensator is a section of waveguide integrated on the gain chip.

29. The phase compensator of the claim 28 wherein the waveguide changes its optical refractive index by injecting current in it.

30. The laser cavity of the claim 21 wherein at least one of the two R-etalons has an end mirror reflector comprising one of band-pass filter, low pass filter, high-pass filter, special filter to compensate the gain curve of the gain chip.

31. A R-etalon comprising:
two polarization rotators;
one linear polarizers;
two reflector; and
one cavity compensator;
the components arranged in the sequence: the linear polarizer, the first polarization rotator, the first reflector, the second polarization rotator (or the cavity compensator), the cavity compensator (or the second polarization rotator), the second reflector;
Wherein the cavity compensator and the second polarization rotator determine the FSR of the R-etalon.

32. The R-etalon of claim 31 wherein the two polarization rotators are Faraday rotator.

33. The polarization rotator of claim 32 wherein the Faraday rotator can rotate the polarization 45 degree.

34. The R-etalon of claim 31 wherein the two polarization rotators are quarter waveplate.

35. The two polarization rotators of claim 34 wherein the optical axes of the quarter waveplates are set 45 degree against the polarization axis of the polarizer.
